(19) United States
(12) Patent Application Publication
(10) Pub. No.: US 2011/0302821 A1
(43) Pub. Date: Dec. 15, 2011

(54) Adhesive Trap Device

(75) Inventor: Enzo Domenico Casagrande, Pontypidd (GB)

(73) Assignee: AgriSense-BCS Limited, Pontypridd (GB)

(21) Appl. No.: 12/994,217

(22) PCT Filed: Apr. 29, 2009
(86) PCT No.: PCT/GB2009/001080

§ 371 Date: Feb. 15, 2011

(30) Foreign Application Priority Data
May 29, 2008 (GB) 0809762.8

(51) Int. Cl. A01M 99/00; A01M 1/10; A01M 1/14; A01M 23/00

(52) U.S. Cl. 43/58

(57) ABSTRACT

A trap device (1) has an adhesive layer (3) carried on a substrate (2) and a separator structure (4) having spaced proud standing portions (15), standing proud with respect to the adhesive layer (3). The proud standing portions (15) of the separator structure (4) are typically distributed across the adhesive layer (3) to ensure that an overlaying layer is held away from contact with adhesive layer (3) over substantially the entire adhesive layer (3). A cover (22a) may be positioned over the separator structure (24).

The present invention relates to an adhesive trap device, particularly such a device for trapping pests.

Adhesive based trapping devices have been used for many years to catch a wide array of, usually, pest animals. These include cockroach traps, moth trap, fly traps and rodent traps. When these products are produced the usual practice is to cover the adhesive layer with a cover paper material. This is usually a silicone coated material which peels away easily from the adhesive layer exposing the surface for when the product is put to use. The cover paper has a number of functions. It protect the adhesive layer from contamination and allows the device to be folded up or stacked without the glue coming into contact with other surfaces to which it could become attached. Examples of this are known cockroach trapping device.

A problem with the prior art cover arrangements is that the user must remove the cover before the product can be used. This has various implications. Firstly removing the cover takes time and can sometimes be awkward and difficult. When a user has many traps to place in the course of a day, this can add up to a significant amount of time. Added to this that the user must carry the removed cover papers until they be disposed of

The second issue with the cover papers is that the need to remove them makes it difficult to develop “ready to use” products where there is no need for the user to prepare/assemble the product before use.

The alternative way to protect the adhesive is to apply it into recessed cavities so that its surface is below the profile of the device and which, therefore, prevents the glue coming in contact when devices are stacked or folded. Examples of these are some of the rodent trapping devices where the glue is poured into a moulded shape and where traps are then packed face to face. This option is very cumbersome and restricts the type of product presentation and production techniques to make the product.

A further alternative is to use a weak adhesive that will break away from any surface they come in contact with. Examples of these are the fly coils once commonly used. The adhesive coated surfaces are wound onto themselves. All sides of the device are therefore coated. The product is activated by pulling the coils out shearing the adhesive to form the product in use. This option is very restrictive in both the type of glue that can be used and also the presentation of the product. Adhesives suitable for this presentation are often not suitable for trapping target pests and the transfer of adhesive to all surfaces it contacts seriously restricts the type of product presentation that this system can be applied to.

An improved arrangement has now been devised.

According to a first aspect, the present invention provides a trap device comprising:
a substrate;
an adhesive layer carried on the substrate; and,
a separator structure comprising a plurality of spaced proud standing portions, standing proud with respect to the adhesive layer.

The invention enables a planar layer of sufficient rigidity to be laid over the adhesive layer without sticking to the adhesive layer, because it is maintained sufficiently separated from the adhesive layer by the separator structure. This enables a trap to be used that has a cover folded from a non- adhesive zone of the substrate.

According to a second aspect, the present invention therefore provides a trap comprising:
a substrate;
an adhesive layer carried on a portion of the substrate; and,
a separator structure comprising a plurality of spaced proud standing portions, standing proud with respect to the adhesive layer;
wherein the substrate includes a cover portion arranged to be folded over the separator structure to lie adjacent but separated from the adhesive layer.

Also the invention enables traps without cover layers to be laid up into a bundle stack or pack with the substrate of an overlaying trap held adjacent but separated from the adhesive layer of an underlying trap.

According to a further aspect, the invention provides a pack or bundle of traps according to the first aspect of the invention, wherein the bundle is provided as a series of traps the substrate of one trap overlaying the separator structure of an underlying trap to lie adjacent but separated from the adhesive layer.

In one embodiment, the separator structure may be embedded in the adhesive layer.

In one embodiment, the separator structure comprises a reticulated structure, such as a net. mesh or grid structure. In a preferred realisation of such an embodiment, the net, mesh or grid structure includes elongate (preferably flexible) filaments connecting intersection nodes. In a preferred embodiment the nodes are thicker than the interconnecting filaments and/or the nodes stand proud of the adhesive layer to a greater degree than the interconnecting filaments.

The separator structure may beneficially be flexible and could be of a plastics material.

The substrate may be of plastics material or other materials such as card, paper or laminates. Typically the sheet material will be in sheet or strip form. The substrate will need to have a certain rigidity in order to ensure that when laid up one over another the substrate of an overlaying trap is held away from contact with the adhesive layer of an underlying trap. Substrate thicknesses in the region of 200 um or more have been found suitable for card or plastics substrates. In certain embodiments, the substrate can be cut to form a preferred shape such as coil form or other arrangement. In certain embodiments the substrate can be folded to form a three dimensional structure incorporating the adhesive layer.

In an alternative embodiment, the separator structure may comprise a structure formed in the substrate, and arranged to stand proud of the adhesive. For example proud standing structures such as ridges, dimples or domes may be formed in the substrate, and adhesive applied to the non-raised portions of the substrate.

In an alternative embodiment the separator structure may be secured to or through the substrate. For example the separator structure may be stapled or stitched to the substrate and extend through the adhesive layer top stand proud of the adhesive layer.

Beneficially, the trap comprises an adhesive zone and the separator structure is distributed over 50% or more of the adhesive zone. Beneficially the separator structure is distributed over 80% or more of the adhesive zone. Most preferably the separator structure is distributed over 90% or more of the adhesive zone.

In a preferred embodiment separator structure is distributed to extend at least adjacent to peripheral portions of the adhesive zone and also preferably in the central region of the adhesive zone.

It is preferred that the majority of the adhesive layer surface of the adhesive zone of the trap is left exposed despite the presence of the separator structure. Beneficially, the area taken up by the separator structure is less than 20% of the total area the adhesive layer. In certain embodiments, the area taken up by the separator structure is less than 10% of the total area the adhesive layer.

In most embodiments the proud standing projections are non-adhesive. In certain embodiments the proud standing projections could be adhesive, and possibly perform adequately. The adhesive contact area would in these circumstances still be reduced (limited to the contact area of the proud standing formations) when compared with a flat/planar adhesive surface.

In certain embodiments, the trap device will include a pest attractant, which may be provided in the form of a pest attractant formulation provided in the adhesive. Alternatively attractants may comprise visual attractants such as patterns applied to the trap device.

The invention will now be further described in specific embodiments, by way of example only and with reference to the accompanying drawings, in which:

FIG. 1 is a schematic plan view of a trap device in accordance with the present invention.

FIG. 2 is a schematic sectional view of the trap device of FIG. 1;

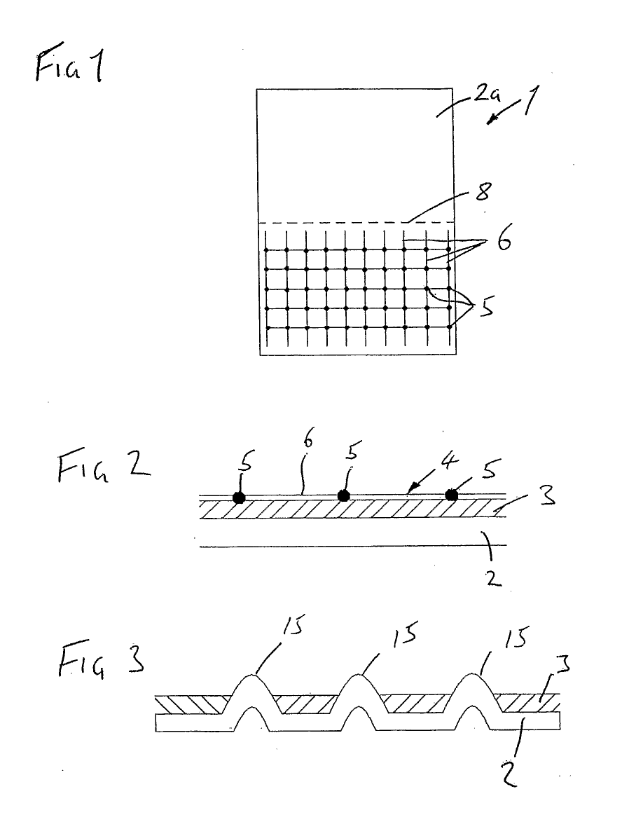

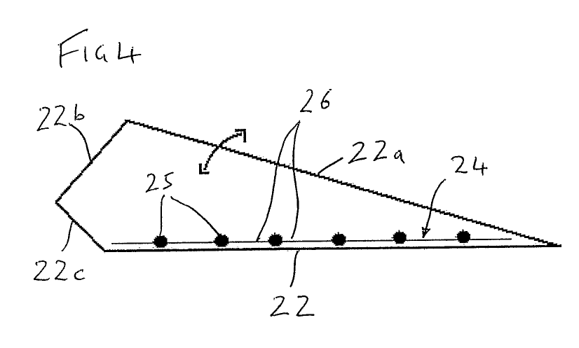

FIG. 3 is a schematic sectional view of an alternative embodiment of trap device in accordance with the invention; and

FIG. 4 is on schematic sectional view of an alternative embodiment of trap device in accordance with the invention.

Referring to the drawings and initially to FIGS. 1 and 2, a trap device, 1 is particularly suited for trapping cockroaches and in the embodiment shown, comprises a 200 um card substrate which is coated on one surface with a layer of standard adhesive glue 3 used for prior art cockroach traps.

A separator structure 4 is, during manufacture, embedded in the adhesive layer 3. The separator structure 4 comprises a reticulated net or mesh having a plurality of relatively thickened nodes 5 interconnected by relatively finer elongate filaments 6. The nodes 5 provided the separation function that will be described in detail later.

The separator net 4 used with most beneficial effect in trials was a Tenax 10 mm square mesh. Other meshes used were a Plastok 10 mm square mesh and Conwed 5 mm mesh.

The 5 mm mesh proved the least effective because the distance between the interconnecting filaments was too small and the cockroaches were able to pass over the trap without being caught by the adhesive layer 3. Similarly the thickness of the filaments for the Plastok 10 mm mesh were to great, enabling the insects to pass over the trap without adhering to the adhesive layer. It is believed that the beneficial technical characteristics which gave the Tenax 10 mm mesh its improved performance relates to the fact that the nodes are thickened (providing the required separation function) but that the interconnected filaments are thin leaving a very great area of the adhesive zone available for trapping the insects.

It should be noted from FIG. 1 that the separator net 4 extends over substantially the entire adhesive zone (below the dashed line 8 in FIG. 1). The separator structure extends to the marginal/peripheral/edge zones of the adhesive zone and is also presented in the central region of the adhesive zone. This ensures that separator nodes 5 are distributed widely over the adhesive layer to ensure that the separation function is achieved widely over the adhesive layer.

In the arrangement shown in FIG. 1 a fold line 8 is provided enabling a portion of the substrate 2a that is not coated with adhesive to fold over to lie in contact with the separator structure. In the folded over configuration, the nodes 5 of the separator structure 4 hold the cover portion 2a clear of the adhesive layer 3 of the trap. In this embodiment it is shown that a trap can be provided having a folded over cover layer which lies adjacent to the adhesive layer 3 of the trap but separated there from by the separator 4. The trap can be transported for use with the cover layer 2a folded into the covering position and simply folded back in order to prime the trap for use.

A similar embodiment is shown in FIG. 4 in which a trap is folded from a card substrate to have a cover portion 22a and two end flaps 22b, 22c which are folded and glued to one another. In FIG. 4 the trap is shown in a partially open position. In the closed position the cover portion 22a lies over the adhesive zone 22 in which is embodied in separator net 24. The nodes 25 separate the cover 22a from the adhesive zone. The trap is transported in a collapsed, flat condition with the cover 22 a in the cover position, and can be deployed for use by pressing on the opposed edges covering the cover portion 22a and the end flaps 22b, 22c to ‘pop up’ to expose the adhesive zone for trapping pests. In these embodiments, the cover portion 22 is deployable from a protective position in which the cover lies contiguous with the separator structure and pest access to the adhesive layer is inhibited, and an access configuration in which the cover is displaced from the separator structure permitting pest access to the adhesive layer. The cover portion may accordingly comprise a ‘pop up’ cover that is secured to the device at opposed edges of the cover in both the protective and access configurations.

Alternatively a different embodiment of trap device can be provided without the cover layer 2a, 22a. In this embodiment a number of traps can be laid up one over the other with the substrate 2 of an overlying trap held adjacent, but separated from the adhesive layer 3 of an underlying trap by means of contact with the separator structure 4. A bundle or stack of traps laid up in this way can be quickly and conveniently deployed without the need for cover layers to be removed as is required in the prior art.

In the arrangement shown in FIG. 3, during manufacture a series of raised dimples 15 are pressed into the substrate 2. In certain embodiments it is envisaged that these dimples will be pressed in following application of the adhesive layer 3 and may stretch and break the adhesive layer. The dimples 15 project (stand proud) to provide a non adhesive structure standing proud of the adhesive layer 3. The dimples 15 correspond to the nodes 5 and provide the same separator structure function.

In certain embodiments it is envisaged that ridges or other proud standing formations can be provided.

It is further envisaged that in certain embodiments, such as a variant of the embodiment of FIG. 3, the dimples may be formed in the substrate and remain coated by an adhesive layer 3. In such an arrangement the total contact area is significantly reduced when compared to the contact area of a single planar adhesive layer, and many benefits of the invention may be provided, even in such an embodiment.

It will be appreciated that specific variations from the embodiments shown may be made without departing from the fundamental scope and nature of the invention. The invention provides significant benefit over the prior art in terms of providing rapid deployment traps and traps including fold over cover structures.

1. A trap device comprising:
a substrate;
an adhesive layer carried on the substrate; and,
a separator structure comprising a plurality of spaced proud standing portions, standing proud with respect to the adhesive layer.

2. The trap device according to claim 1, wherein the proud standing portions of the separator structure are distributed across the adhesive layer to ensure that an overlaying layer is held away from contact with adhesive layer over substantially the entire adhesive layer.

3. The trap device according to claim 1 further comprising a cover positioned over the separator structure.

4. The trap device according to claim 1, wherein the substrate includes a cover portion or flap arranged to be folded over the separator structure to lie adjacent but separated from the adhesive layer.

5. The trap device according to claim 3, wherein the cover is deployable from a protective position in which the cover lies contiguous with the separator structure and pest access to the adhesive layer is inhibited, and an access configuration in which the cover is displaced from the separator structure permitting pest access to the adhesive layer.

6. The trap device according to claim 5, wherein the cover is a pop up cover that is secured to the device at opposed edges of the cover in both the protective and access configurations.

7. The trap device according to claim 1, wherein the separator structure is embedded in the adhesive layer.

8. The trap device according to claim 1, wherein the separator structure further comprises a reticulated structure.

9. The trap device according to claim 8, wherein the separator structure further comprises a mesh or grid structure.

10. The trap device according to claim 9, wherein the mesh or grid structure comprises filaments connecting intersection nodes.

11. The trap device according to claim 10, wherein the nodes stand proud of the adhesive layer to a greater degree than the connecting filaments.

12. The trap device according to claim 1, wherein the separator structure further comprises a structure formed in the substrate.

13. The trap device according to claim 1, wherein the separator structure is secured to or through the substrate.

14. The trap device according to claim 1 further comprising an adhesive zone, and the separator structure is distributed over 50% or more of the adhesive zone.

15. The trap device according to claim 1 further comprising an adhesive zone, and the separator structure is distributed to extend to peripheral portions of the adhesive zone and also in the central region of the adhesive zone.

16. The trap device according to claim 1 further comprising an adhesive zone, and the area taken up by the separator structure being less than 20% of the total area the adhesive layer.

17. The trap device according to claim 1, wherein the proud standing portions are non-adhesive.

18. The trap device according to claim 1 further comprising a pest attractant.

19. The trap device according to claim 18, wherein the pest attractant comprises a pest attractant formulation provided in the adhesive layer.

20. A bundle or stack of trap devices according claim 1, wherein the bundle or stack is provided as a series of trap devices the substrate of one trap device overlaying in contact with the separator structure of an underlying trap device to lie adjacent but separated from the adhesive layer.
